(19) United States
(12) Patent Application Publication
(10) Pub. No.: US 2025/0020872 A1
(43) Pub. Date: Jan. 16, 2025

(54) FIBER POLARITY MAPPINGS

(71) Applicant: viaPhoton, Inc., Aurora, IL (US)

(72) Inventors: Nathan Eric BENTON, Dallas, TX (US); Jeffrey Earl JONES, Stewartstown, PA (US)

(21) Appl. No.: 18/770,358

(22) Filed: Jul. 11, 2024

Related U.S. Application Data
(60) Provisional application No. 63/526,442, filed on Jul. 12, 2023.

(51) Int. Cl. G02B 6/40; G02B 6/38

(52) U.S. Cl. CPC G02B 6/406; G02B 6/3893

(57) ABSTRACT

An apparatus comprises a cable. At least one first connector is affixed to a first end of the cable and each first connector comprising a plurality of first positions. At least two second connectors are affixed to a second end of the cable and each second connector comprising a plurality of second positions. A polarity mapping defines a plurality of connections between the least one first connector and the at least two second connectors. Each of the at least one first connector is optically coupled to each of the at least two second connectors.

### CROSS-REFERENCE TO RELATED APPLICATIONS

This Application claims the benefit of U.S. Provisional Application Ser. No. 63/526,442, filed Jul. 12, 2023, which is hereby incorporated by reference for all purposes.

### BACKGROUND

Fiber polarity refers to the orientation or alignment of the optical fibers within the connectors. In other words, fiber polarity specifies the direction in which light travels from one end of the cable to the other. In optical fiber networks, fiber polarity is mapped between transmitters and receivers to ensure proper connectivity and signal transmission. Incorrect polarity due to routing errors in manufacturing or installation could lead to signal failure, even if the cable is otherwise functional.

To address this issue, the Telecommunication Industries Association/Electronic Industries Alliance (TIA/EIA) has promulgated a recommended polarity scheme known as the “A-B-C” method. This method defines three different polarity methods (A, B, and C) within the connectors and assigns them specific roles. A ‘universal’ polarity method has also been separately developed. Polarity schemes are specific when using fiber arrays (more than 2 fibers) and array connectors.

Both the A-B-C and Universal polarity methods addresses legacy equipment designs using LC and MPO connectors. However, neither the A-B-C nor the Universal polarity methods addresses connections in new higher density fiber optic communications.

### SUMMARY

In general, one or more embodiments of the invention relate to an apparatus. The apparatus comprises a cable. At least one first connector is affixed to a first end of the cable and each first connector comprising a plurality of first positions. At least two second connectors are affixed to a second end of the cable and each second connector comprising a plurality of second positions. A polarity mapping defines a plurality of connections between the least one first connector and the at least two second connectors. Each of the at least one first connector is optically coupled to each of the at least two second connectors.

Other embodiments of the invention relate to an apparatus. The apparatus comprises a cable. At least two first connectors are affixed to a first end of the cable and each first connector comprising a plurality of first positions. At least four second connectors are affixed to a second end of the cable and each second connector comprising a plurality of second positions. A polarity mapping defines a plurality of connections between the least two first connectors and the at least four second connectors. Each of the at least two first connectors is optically coupled to each of the at least four second connectors.

Other aspects of the invention will be apparent from the following description and the appended claims.

### BRIEF DESCRIPTION OF DRAWINGS

FIGS. 1A, 1B and 1C show a cable in accordance with one or more embodiments of the invention.

FIG. 2 shows the polarity mapping of a cable in accordance with one or more embodiments of the invention.

FIGS. 3A and 3B show a detailed representation of the channel lane mapping for a Quad Small Form Factor Pluggable (QSFP) transceiver in accordance with one or more embodiments of the invention.

FIG. 4 shows a fiber polarity mapping for a single mode (SM) 2×QSFP to 2×QSFP mesh configuration in accordance with one or more embodiments of the invention.

FIG. 5 shows a cable in accordance with one or more embodiments of the invention.

FIG. 6 shows the polarity mapping of a cable in accordance with one or more embodiments of the invention.

FIG. 7 shows a detailed representation of the channel lane mapping for a Quad Small Form Factor Pluggable (QSFP) transceiver in accordance with one or more embodiments of the invention.

FIG. 8 shows a fiber polarity mapping for a single mode (SM) 4×QSFP to 4×QSFP mesh configuration in accordance with one or more embodiments of the invention.

Like elements in the various figures are denoted by like reference numerals for consistency.

### DETAILED DESCRIPTION

The embodiments described herein provide a polarity method for a new datacenter configuration. This polarity method can be employed in Quad Small Form Factor Pluggable (QSFP) transceivers, such as Datacenter graphics processing unit (GPU) transceiver modules, which are transmitting and receiving in a split channel (mesh) configuration.

Datacenter GPU (graphics processing unit) transceiver modules must be connected in large numbers to support new applications such as generative artificial intelligence that utilize GPUs. The GPU modules have QSFP transceivers with 4 pairs of optical inputs that must be connected end-to-end. In the disclosed embodiments, these end-to-end connections are made using a trunk cable and an array jumper cable.

In the disclosed embodiments, a trunk cable is used to traverse significant distances across the datacenter. The trunk cable may follow industry standards for polarity. For example, the trunk cable may follow the TIA/EIA-568 Method B polarity standard.

For the array jumper cable, a mesh architecture is implemented where individual 2-lane channels from a QSFP on one side route to multiple different QSFPs on the other and vice versa. The individual channels are configured in the switch and are routed via 2-fiber lanes to the receiving QSFP. The mesh architecture is accomplished within the array cable without the cost and complexity of modules (or cassettes) to provide the cross connects that are needed to support the multiple different polarity assignments.

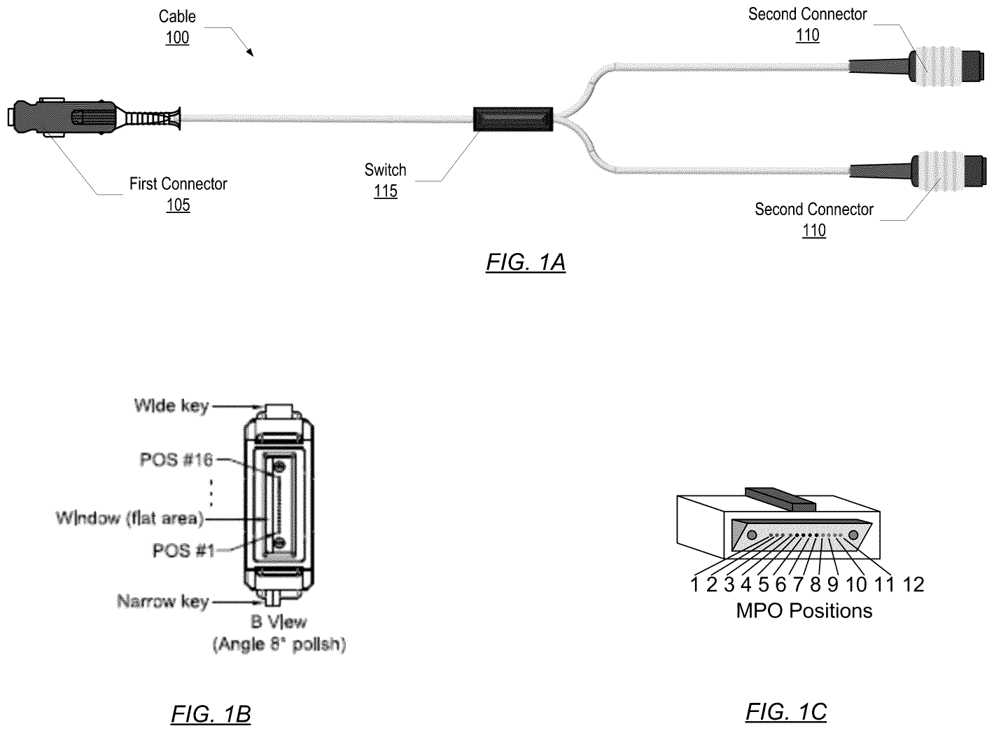

Turning to FIG. 1A, a cable (100) is shown. In one embodiment, the cable is a 16-fiber array cable in a jumper application, which may also be referred to as a 16-fiber array jumper. The cable (100) includes a first connector (105) and two second connectors (110).

In one embodiment, the first connector (105) is a 16-fiber (16f) optical connector, which may be a very small form factor (VSFF) connector, which may be a Senko SN-MT16, a USCONEC 16f MMC, 3M 16f EBO and the like. The first connector (105) may be connected to an end of a type B trunk cable. The jumper array cable that connects the SN-MT16 connector to two MPO8 connectors, effectively splitting the 16 fibers into two sets of 8 fibers each.

Cable (100) implements a mesh architecture, where individual 2-lane channels from a QSFP on one side will route to multiple different QSFPs on the other and vice versa. The individual channels are configured in the switch (115) and are routed via 2-fiber lanes to the second connectors (110).

FIG. 1B shows the first connector (105). As illustrated, the first connector (105) may have positions for 16 optical fibers of which are mapped to positions in the second connectors (110). The first connector (105) is optically coupled to each of the two second connectors (110).

FIG. 1C illustrates one of the second connectors (110). In one embodiment, each second connectors (108) may have positions for 12 optical fibers of which 8 positions are mapped to positions in the first connector (105). The second connector (110) includes 12 positions. Each of the second connectors (108) is a Multi-Fiber Push On (MPO) optical fiber connector. The second connectors (110) may be configured to integrate with Quad small form-factor pluggable (QSFP) transceivers having transmit lanes positions 1-4 on the left and receiver lanes 9-12on the right when viewed in the key up perspective.

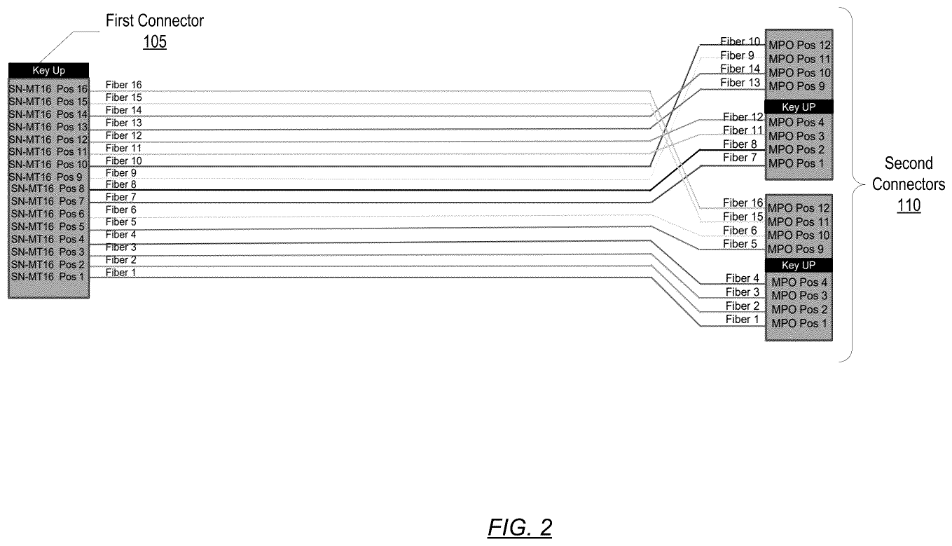

Turning to FIG. 2, the polarity mapping (100) defines connections (shown by the fibers (102)) for a 16 fiber (16f) array between the first connector (105) and the second connectors (108) used in a jumper application. In one embodiment, a 16-fiber array created using the polarity mapping (100) may be connected to an end of a type B trunk cable.

The polarity mapping defines the sequence of connections between the first and second connectors. Each fiber in the 16-fiber array is mapped to specific positions in the MPO connectors to ensure correct signal alignment. The maintain the integrity of data transmission by aligning the transmitting (Tx) and receiving (Rx) fibers correctly.

The polarity mapping defines the sequence of fibers shown in FIG. 2 and the table below for fibers connected from one 16-fiber connector (SN-MT16) to 2 MPO connectors. The polarity mapping of cable (100) is illustrated in FIG. 2, and detailed in Table 1.

TABLE 1
Polarity Mapping of Cable (100)

| Fiber | First Connector Position | Second Connector Position |
|---|---|---|
| 16 | SN-MT16 position 16 | MPO1 position 12 |
| 15 | SN-MT16 position15 | MPO1 position 11 |
| 14 | SN-MT16 position14 | MPO2 position 10 |
| 13 | SN-MT16 position13 | MPO2 position 9 |
| 12 | SN-MT16 position12 | MPO2 position 4 |
| 11 | SN-MT16 position11 | MPO2 position 3 |
| 10 | SN-MT16 position10 | MPO2 position 12 |
| 9 | SN-MT16 position9 | MPO2 position 11 |
| 8 | SN-MT16 position8 | MPO2 position 2 |
| 7 | SN-MT16 position7 | MPO2 position 1 |
| 6 | SN-MT16 position6 | MPO1 position 10 |
| 5 | SN-MT16 position5 | MPO1 position 9 |
| 4 | SN-MT16 position4 | MPO1 position 4 |
| 3 | SN-MT16 position3 | MPO1 position 3 |
| 2 | SN-MT16 position2 | MPO1 position 2 |
| 1 | SN-MT16 position1 | MPO1 position 1 |

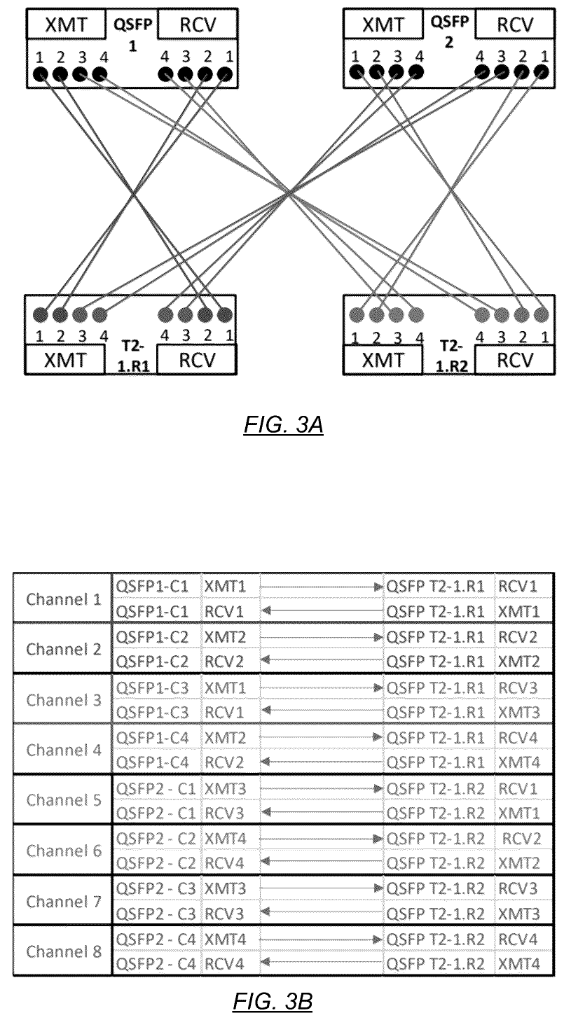

Turning now to FIGS. 3A and 3B, a detailed representation of the channel lane mapping for a Quad Small Form Factor Pluggable (QSFP) transceiver setup is shown in a split-channel (mesh) configuration. FIGS. 3A and 3B illustrate the connections between transmit (XMT) and receive (RCV) lanes across two QSFP transceivers, ensuring correct signal polarity and alignment.

Each QSFP transceiver has four transmit (XMT) lanes and four receive (RCV) lanes. Each XMT lane on the QSFP transceivers is mapped to a corresponding RCV lane on another QSFP transceiver. Each RCV lane on the QSFP transceivers is mapped to a corresponding XMT lane on another QSFP transceiver.

FIG. 3B is a table showing an array fiber jumper position of connections for each channel lane napping from QSFP1 to QSFP2 illustrated in FIG. 3A.
As shown, the XMT lanes from one QSFP transceiver are mapped to the RCV lanes of another QSFP transceiver, ensuring correct signal polarity. This setup allows for a flexible and efficient interconnection of QSFP transceivers, supporting a split-channel (mesh) configuration that are typical in high-density data centers and other environments requiring reliable and high-speed optical communication.

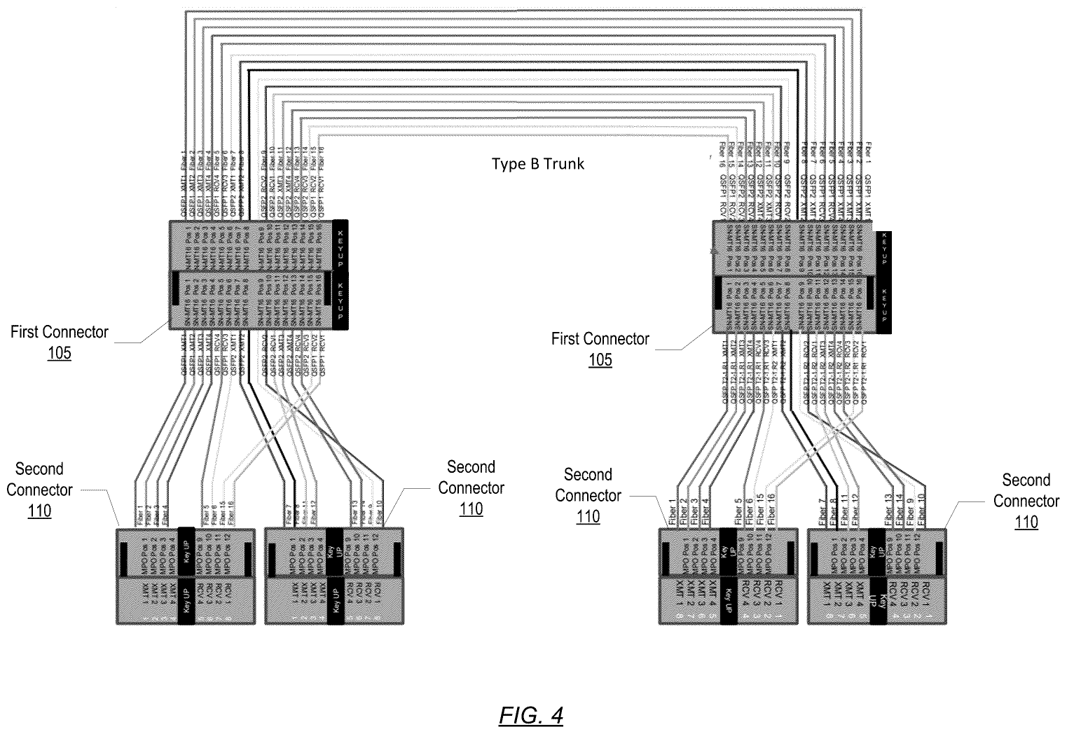

Referring now to FIG. 4, a view of the fiber polarity mapping for a single mode (SM) 2×QSFP to 2×QSFP mesh configuration using cable (100). This mapping illustrates the connections and polarity changes necessary to ensure proper signal transmission and reception across multiple QSFP transceivers.

The Type B trunk cable is a consecutive fiber cable with a key-up orientation on both ends. The trunk cable reverses the MPO positions on one side to maintain proper polarity. The polarity change is highlighted where Fiber 16 from End A maps to SN-MT16 Position 1 on End B. This change ensures that the transmit (XMT) port on one end aligns with the receive (RCV) port on the other end.
The fibers from SN-MT16 Pos 1 to Pos 16 on End A are mapped to corresponding positions on End B, with a polarity change for Fiber 16 to SN-MT16 Position 1, ensuring XMT to RCV alignment.

First connectors (105) of a cable (100) is connected at both ends (End A and End B) of the Type B trunk cable. The First connectors (105) connector includes 16 positions for optical fibers.

QSFP Transceivers are configured with transmit lanes (1-4) on the left and receive lanes (9-12) on the right when viewed in the key-up perspective. The QSFP transceivers are male (pinned) and are shown at both ends of the configuration, labeled as QSFP 1 and QSFP 2.

The jumpers at both ends of the trunk cable is consistent, using the same fiber mapping. This consistency simplifies installation and maintenance, enabling jumpers with a common fiber mapping to be used regardless of the direction of signal transmission.

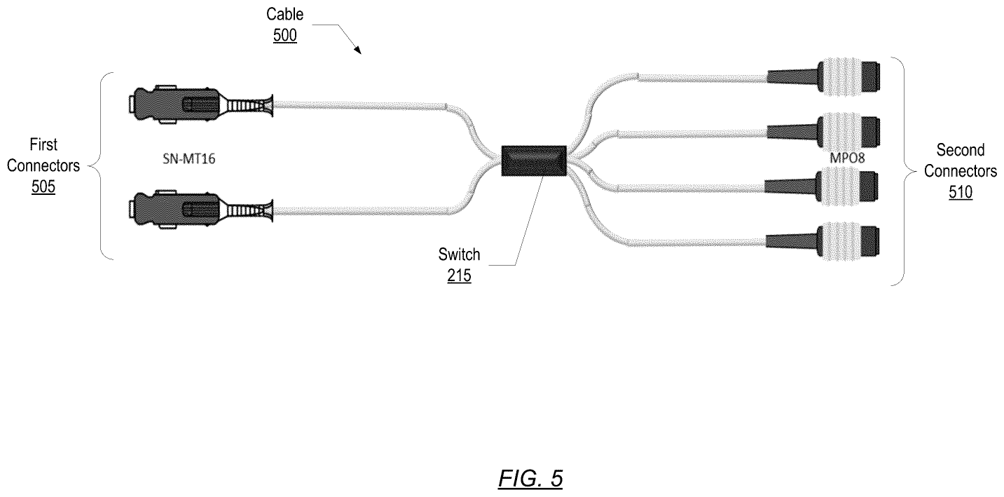

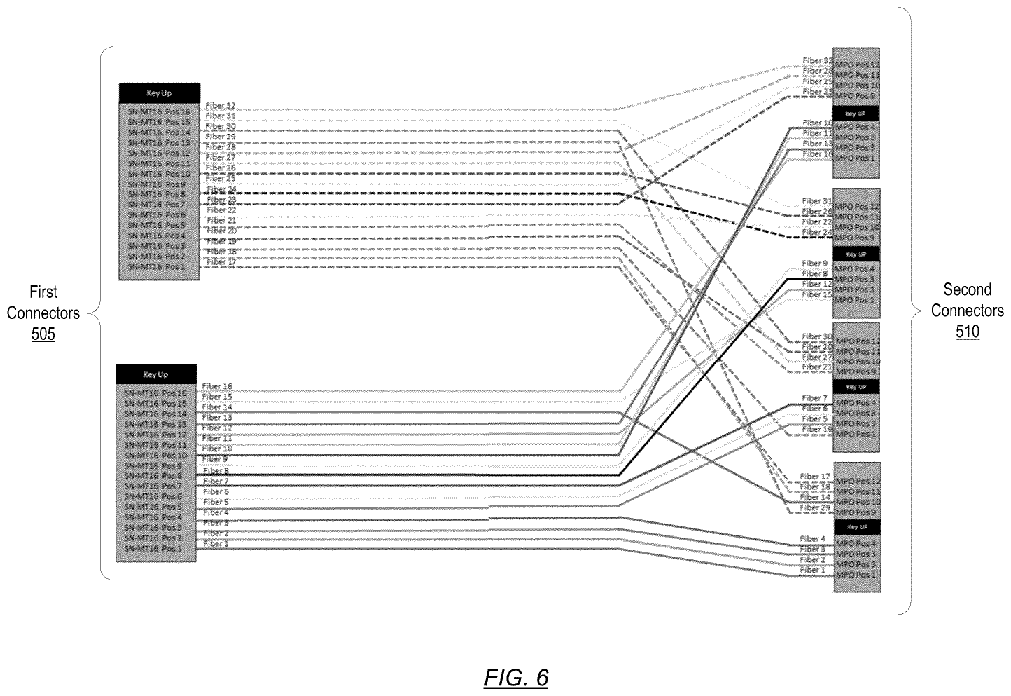

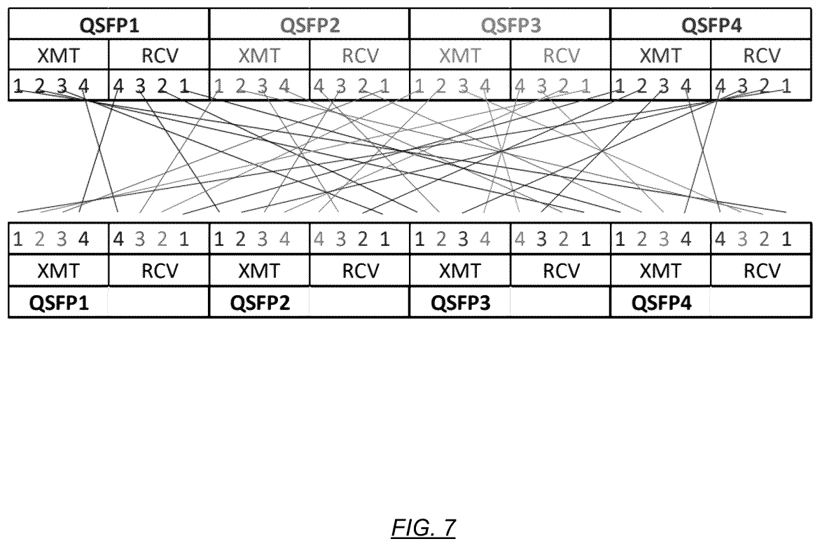

Turning to FIG. 5, the cable (500) is shown. In one embodiment, the cable is a 32-fiber array cable in a jumper application, which may also be referred to as a 32-fiber array jumper. The cable (500) includes the two first connectors (505) and the four second connectors (510).

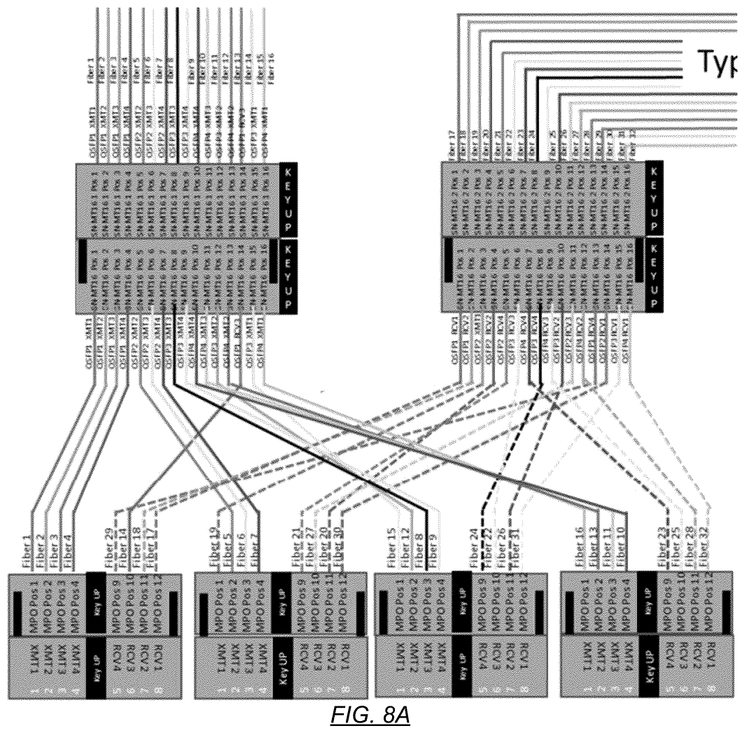

Turning to FIG. 6, a polarity mapping defines connections (shown by the fibers (202)) for cable (500) array between the first connectors (505) and the second connectors (510) used in a jumper application. In one embodiment, a 32-fiber array created using the polarity mapping (200) may be connected to ends of type B trunk cables. The first connectors (505) are each connected to each of the two second connectors (510).

In one embodiment, each of the first connectors (505) is a 16-fiber (16f) optical connector, which may be a very small form factor (VSFF) connector, which may be a Senko SN-MT16, a USCONEC 16f MMC, and the like. Each of the second connectors (510) are an MPO optical fiber connector. In one embodiment, the second connectors (510) each have positions for 12 optical fibers of which 8 positions are mapped to positions in the first connectors (505).

The polarity mapping defines the sequence of fibers shown in FIG. 6 and the table below for fibers connected from two 16-fiber connectors (SN-MT16) to 4 MPO connectors.

TABLE 2
Polarity Mapping of Cable (500)

| Fiber | First Connector Position | Second Connector Position |
|---|---|---|
| 32 | SN-MT16-2 position 32 | MPO4 position 12 |
| 31 | SN-MT16-2 position 31 | MPO3 position 12 |
| 30 | SN-MT16-2 position 30 | MPO2 position 12 |
| 29 | SN-MT16-2 position 29 | MPO1 position 9 |
| 28 | SN-MT16-2 position 28 | MPO4 position 11 |
| 27 | SN-MT16-2 position 27 | MPO2 position 10 |
| 26 | SN-MT16-2 position 26 | MPO3 position 11 |
| 25 | SN-MT16-2 position 25 | MPO4 position 10 |
| 24 | SN-MT16-2 position 24 | MPO3 position 9 |
| 23 | SN-MT16-2 position 23 | MPO4 position 9 |
| 22 | SN-MT16-2 position 22 | MPO3 position 10 |
| 21 | SN-MT16-2 position 21 | MPO2 position 9 |
| 20 | SN-MT16-2 position 20 | MPO2 position 11 |
| 19 | SN-MT16-2 position 19 | MPO2 position 1 |
| 18 | SN-MT16-2 position 18 | MPO1 position 11 |
| 17 | SN-MT16-2 position 17 | MPO1 position 12 |
| 16 | SN-MT16-1 position 16 | MPO4 position 1 |
| 15 | SN-MT16-1 position 15 | MPO3 position 1 |
| 14 | SN-MT16-1 position 14 | MPO1 position 10 |
| 13 | SN-MT16-1 position 13 | MPO4 position 2 |
| 12 | SN-MT16-1 position 12 | MPO3 position 2 |
| 11 | SN-MT16-1 position 11 | MPO4 position 3 |
| 10 | SN-MT16-1 position 10 | MPO4 position 4 |
| 9 | SN-MT16-1 position 9 | MPO3 position 4 |
| 8 | SN-MT16-1 position 8 | MPO3 position 3 |
| 7 | SN-MT16-1 position 7 | MPO2 position 4 |
| 6 | SN-MT16-1 position 6 | MPO2 position 3 |
| 5 | SN-MT16-1 position 5 | MPO2 position 2 |
| 4 | SN-MT16-1 position 4 | MPO1 position 4 |
| 3 | SN-MT16-1 position 3 | MPO1 position 3 |
| 2 | SN-MT16-1 position 2 | MPO1 position 2 |
| 1 | SN-MT16-1 position 1 | MPO1 position 1 |

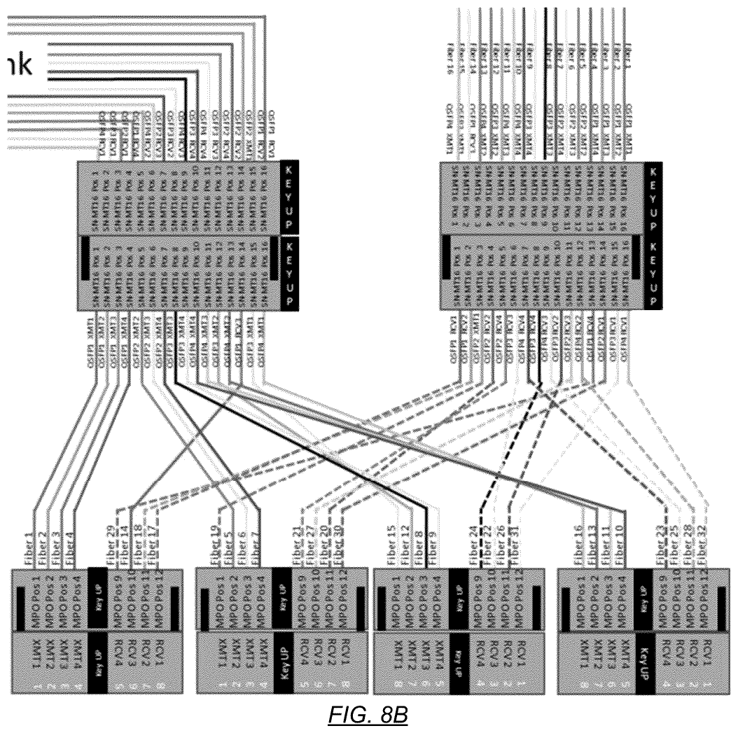

FIG. 7 is a detailed representation of the channel lane mapping for a Quad Small Form Factor Pluggable (QSFP) transceiver setup is shown in a split-channel (mesh) configuration. FIG. 7 illustrate the connections between transmit (XMT) and receive (RCV) lanes across four QSFP transceivers, ensuring correct signal polarity and alignment.

Each QSFP transceiver has four transmit (XMT) lanes and four receive (RCV) lanes. Each XMT lane on the QSFP transceivers is mapped to a corresponding RCV lane on another QSFP transceiver. Each RCV lane on the QSFP transceivers is mapped to a corresponding XMT lane on another QSFP transceiver.
As shown, the XMT lanes from one QSFP transceiver are mapped to the RCV lanes of another QSFP transceiver, ensuring correct signal polarity. This setup allows for a flexible and efficient interconnection of QSFP transceivers, supporting a split-channel (mesh) configuration that are typical in high-density data centers and other environments requiring reliable and high-speed optical communication.

Referring now to FIGS. 8A and 8B, a view of the fiber polarity mapping for a single mode (SM) 4×SFP to 4×QSFP mesh configuration using cable (500). This mapping illustrates the connections and polarity changes necessary to ensure proper signal transmission and reception across multiple QSFP transceivers.

The Type B trunk cable is a consecutive fiber cable with a key-up orientation on both ends. The trunk cable reverses the MPO positions on one side to maintain proper polarity. The fibers from SN-MT16 Pos 1 to Pos 16 on End A (FIG. 8A) are mapped to corresponding positions on End B (FIG. 8B), with a polarity change for Fiber 16 to SN-MT16 Position 1, ensuring XMT to RCV alignment.

First connectors (105) of a cable (500) are connected at both ends (End A and End B) of the Type B trunk cables. Each First connectors (105) connector includes 16 positions for optical fibers.

QSFP Transceivers are configured with transmit lanes (1-4) on the left and receive lanes (9-12) on the right when viewed in the key-up perspective. The QSFP transceivers are male (pinned) and are shown at both ends of the configuration, labeled as QSFP, QSFP 2, QSFP 3, and QSFP 4.

The jumpers at both ends of the trunk cable is consistent, using the same fiber mapping. This consistency simplifies installation and maintenance, enabling jumpers with a common fiber mapping to be used regardless of the direction of signal transmission.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, “or” is an “inclusive or” and, as such includes “and.” Further, items joined by an or may include any combination of the items with any number of each item unless expressly stated otherwise.

The figures of the disclosure show diagrams of embodiments that are in accordance with the disclosure. The embodiments of the figures may be combined and may include or be included within the features and embodiments described in the other figures of the application. The features and elements of the figures are, individually and as a combination, improvements to the technology of fiber pedestals. The various elements, systems, components, and steps shown in the figures may be omitted, repeated, combined, and/or altered as shown from the figures. Accordingly, the scope of the present disclosure should not be considered limited to the specific arrangements shown in the figures.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

What is claimed is:

1. An apparatus, comprising:
a cable;
at least one first connector affixed to a first end of the cable and each first connector comprising a plurality of first positions;
at least two second connectors affixed to a second end of the cable and each second connector comprising a plurality of second positions;
a polarity mapping defining a plurality of connections between the least one first connector and the at least two second connectors, wherein each of the at least one first connector is optically coupled to each of the at least two second connectors.

2. The apparatus of claim 1, wherein the cable is a fiber array jumper.

3. The apparatus of claim 1, wherein each first connector is a 16-fiber (16f) very small form factor (VSFF) optical connector.

4. The apparatus of claim 1, wherein each first connector is configured to connect to a Type B trunk cable.

5. The apparatus of claim 1, wherein each second connector is a multi-fiber push on (MPO) connector.

6. The apparatus of claim 1, wherein each second connector is configured to connect to a Quad Small Form Factor Pluggable (QSFP) transceiver in a split-channel (mesh) configuration.

7. The apparatus of claim 1, wherein the plurality of second positions comprises positions for 12 optical fibers of which 8 positions are mapped to first positions in the first connectors.

8. The apparatus of claim 1, further comprising:
a fiber ribbon comprising 16 optical fibers, wherein:
a first set of the optical fibers is mapped from the first connector to a first one of the second connectors; and.
a second set of the optical fibers is mapped from the first connector to a second one of the second connectors.

9. The apparatus of claim 8, wherein the mapping enables individual channel lane mapping to a Quad Small Form Factor Pluggable (QSFP) transceiver in a split-channel (mesh) configuration.

10. The apparatus of claim 9, wherein the multiple instances of the apparatus having a same polarity mapping can be used on both an XMT-RCV side and an RCV-XMT side of a QSFP channel.

11. An apparatus, comprising:
a cable;
at least two first connectors affixed to a first end of the cable;
at least four second connectors affixed to a second end of the cable;
a polarity mapping defining a plurality of connections between the least two first connectors and the at least four second connectors, wherein each of the at least two first connectors is optically coupled to each of the at least four second connectors.

12. The apparatus of claim 11, wherein the cable is a fiber array jumper.

13. The apparatus of claim 11, wherein each first connector is a 16-fiber (16f) very small form factor (VSFF) optical connector.

14. The apparatus of claim 11, wherein each first connector is configured to connect to a Type B trunk cable.

15. The apparatus of claim 11, wherein each second connector is a multi-fiber push on (MPO) connector.

16. The apparatus of claim 1, wherein each second connector is configured to connect to a Quad Small Form Factor Pluggable (QSFP) transceiver in a split-channel (mesh) configuration.

17. The apparatus of claim 1, wherein the plurality of second positions comprises positions for 12 optical fibers of which 8 positions are mapped to first positions in the first connectors.

18. The apparatus of claim 1, further comprising:
a first fiber ribbon comprising 16 optical fibers, wherein:
a first set of the optical fibers is mapped from the first connectors to a first one of the second connectors;
a second set of the optical fibers is mapped from the first connectors to a second one of the second connectors;
a third set of the optical fibers is mapped from the first connectors to a third one of the second connectors; and.
a fourth set of the optical fibers is mapped from the first connectors to a fourth one of the second connectors; and
a second fiber ribbon comprising 16 optical fibers, wherein:
a fifth set of the optical fibers is mapped from the first connectors to a first one of the second connectors;
a sixth set of the optical fibers is mapped from the first connectors to a second one of the second connectors;
a seventh set of the optical fibers is mapped from the first connectors to a third one of the second connectors; and
an eighth set of the optical fibers is mapped from the first connectors to a fourth one of the second connectors.

19. The apparatus of claim 18, wherein the mapping enables individual channel lane mapping to a Quad Small Form Factor Pluggable (QSFP) transceiver in a split-channel (mesh) configuration.

20. The apparatus of claim 19, wherein the multiple instances of the apparatus having a same polarity mapping can be used on both sides of the 2-fiber lanes of a QSFP channel: XMT to RCV and RCV to XMT.
